(19) United States
(12) Patent Application Publication
(10) Pub. No.: US 2026/0264123 A1
(43) Pub. Date: Sep. 10, 2026

(54) CONTAMINANT IMMOBILISATION IN ASPHALT

(71) Applicants: REMBIND PTY LTD, Kurralta Park (AU); FULTON HOGAN INDUSTRIES PTY LTD, Richmond, VIC (AU)

(72) Inventors: Richard John STEWART, Kurralta Park (AU); Michael THOMPSON, Mile End South (AU)

(21) Appl. No.: 19/164,747

(22) PCT Filed: Mar. 18, 2024
(86) PCT No.: PCT/AU2024/050240

§ 371 Date: Sep. 12, 2025

(30) Foreign Application Priority Data
Mar. 16, 2023 (AU) 2023900726

(51) Int. Cl. B09B 3/23; B09B 3/40; B09B 101/40

(52) U.S. Cl. CPC B09B 3/23; B09B 3/40; B09B 2101/40

(57) ABSTRACT

A method for the stabilisation of contaminants within an asphalt raw material is disclosed. The method comprised mixing the asphalt raw material with an adsorbent under conditions to bind contaminants in the asphalt raw material and stabilise the contaminants under asphalt mixing conditions.

### PRIORITY DOCUMENT

The present application claims priority from Australian Provisional Patent Application No. 2023900726 titled “PFAS IMMOBILISATION IN ASPHALT” and filed on 16 Mar. 2023, the content of which is hereby incorporated by reference in its entirety.

### TECHNICAL FIELD

The present disclosure relates generally to asphalt. In a particular form the present disclosure relates to materials and processes for immobilising contaminants in recycled asphalt.

### BACKGROUND

Asphalt is one of the most highly used products in Australia and New Zealand for road, car park, runway and driveway construction. It is a composite material of aggregate and sand that is bound together with bitumen. Asphalt is applied to surfaces by applying it and then compacting it. Asphalt is commonly mixed at temperatures between 150° C. and 190° C. and laid while hot (so called hot mix asphalt or HMA). It is also possible to lay asphalt in the form of cold mix asphalt (CMA), warm mix asphalt (WMA) and foamed asphalt. CMA is produced by mixing emulsified bitumen, cutback or foamed bitumen with un-heated aggregates.

All asphalt surfaces have a finite lifetime and end of life asphalt is typically dug up and a new asphalt surface is laid in its place. There has been an increasing interest in reclaiming old asphalt for use in new asphalt applications. Addition of reclaimed asphalt pavement (RAP) has the potential to save resources and reduce the energy consumption and CO2 footprint during asphalt mix production. The main drivers to use RAP are raw material shortage, economic reasons and environmental aspects.

A significant problem with using RAP in asphalt mixes is contamination in the original asphalt. One particularly problematic contaminant in used asphalt is per- and polyfluoroalkyl substances (PFAS). PFAS. These are also known as perfluorinated chemicals (PFCs), and are a large group of compounds used in a variety of industries, such as aerospace, automotive, textiles, and electronics. For many years, PFAS were used in firefighting materials and this use (among others) has resulted in many asphalt surfaces being contaminated with PFAS. Unfortunately, the hydrophobicity and negligible rate of natural decomposition of PFAS means that they persist in the environment for long periods of time. Even low levels of bioaccumulation of PFAS can lead to serious health consequences for animals exposed to PFAS contaminated materials. Importantly, leachability of the PFAS from the RAP is a significant risk to groundwater and surface water which can lead to adverse effects on human health and the environment.

To date, PFAS contaminated used asphalt materials have not been suitable for general use or application as RAP for new asphalt mixes due to the PFAS contamination and concerns around the potential for leaching of the PFAS out of the RAP or the new asphalt mixes and possible volatilization of PFAS in the HMA mixing and laying process. However, many airports have large asphalt areas that need to be replaced and these surfaces are commonly contaminated with PFAS because of earlier firefighting activities. This has resulted in contaminated used asphalt being stockpiled at many facilities with very limited prospects for re-use and concerns around the potential for PFAS to leach from the stockpiles into surrounding soil and water. Currently, the main solution available for these stockpiles is landfill disposal which is unsustainable and often cost-prohibitive. Also, the ability of landfills to receive this material is often restricted because of the potential for PFAS to leach from the material at concentrations that exceed landfill acceptance criteria, and potential long-term liabilities caused by PFAS contaminants in landfill leachate collection systems.

There is thus a need to provide materials and processes for treating PFAS contaminated used asphalt so that it can be used as reclaimed asphalt in new asphalt applications. There is also a need for an environmentally sound and sustainable outcome for dealing with PFAS contaminated used asphalt that is consistent with the principles of a Circular Economy approach.

Further aspects and advantages of the method and uses thereof will become apparent from the ensuing description that is given by way of example only.

### SUMMARY

According to a first aspect, there is provided a method for the stabilisation of contaminants within an asphalt raw material, the method comprising mixing the asphalt raw material with an adsorbent under conditions to bind contaminants in the asphalt raw material and stabilise the contaminants under asphalt mixing conditions.

The contaminants that can be stabilised using the method may be PFAS.

The asphalt raw material can be any bitumen material, aggregate material, sand material, soil material or additive material (e.g. tyre crumb) that is suitable for use in new asphalt. For clarity, any one or more of these asphalt raw materials may contain contaminants. Without limitation, the asphalt raw material will typically be used asphalt that is suitable for use as RAP.

If no adsorbent is mixed with the asphalt raw material then contaminants, such as PFAS, may leach from the material at concentrations that exceed environmental acceptance criteria. Furthermore, if the asphalt raw material is then used as RAP the contaminants may be transferred to any newly laid asphalt which will then also face the potential problem of contaminants leaching from the material and into the surroundings.

It will be appreciated that typical “asphalt mixing conditions” can include heating to temperatures up to about 190° C. It will also be appreciated that asphalt is a composite material the presents a highly complex chemical environment that consists of different sized particles, different chemical environments (e.g. hydrophobic), different pH and ionic conditions, a range of volatile and semi-volatile and non-volatile compounds, and different chemical elements in a single asphalt mix. Therefore, “asphalt mixing conditions” include a complex chemical environment that is different from other chemical environments in which adsorbents have been used to bind contaminants, such as soils, for example. In addition to the complex chemical environment for all asphalt mixes and the high heat environment for HMA and possibly also WMA, asphalt mixes present a harsh physical and chemical environment as the components of the asphalt are mixed as well as when the new asphalt is being laid.

The present inventors have surprisingly found that when the asphalt raw material is mixed with the adsorbent using the methods described herein, the treated asphalt raw material can be stored without significant contaminant leaching and it can also be used as RAP and new asphalt formed using the RAP does not undergo significant contaminant leaching. Thus, stabilisation of contaminants afforded by the methods described herein may also lead to immobilisation of the contaminants. This means that the contaminants are less likely to leach out of the asphalt raw material and/or any new asphalt formed using the treated asphalt raw material and that environmental contamination (e.g. groundwater or soil contamination) from the asphalt raw material and/or any new asphalt formed using the treated asphalt raw material is less likely to occur. In other words, PFAS contaminated used asphalt that could not previously be used as RAP in new asphalt applications, can be used after stabilisation with adsorbents.

In addition to reduction in contaminant leaching, if no adsorbent is mixed with the asphalt raw material then some contaminants may volatilise under asphalt mixing conditions which may lead to unacceptable health, safety and environmental outcomes. In contrast, the present inventors have surprisingly found that when the asphalt raw material is mixed with the adsorbent using the methods described herein, the treated asphalt raw material can be exposed to asphalt mixing conditions and temperatures and the PFAS contaminants are volatilized to a much-reduced extent.

The adsorbent that is used in the methods described herein may be a carbon-based adsorbent, a mineral-based adsorbent, a clay-based adsorbent, a biopolymer-based adsorbent, an ion exchange resin or a combination of two or more of the aforementioned.

According to a second aspect, there is provided aggregate and/or bitumen obtained from used asphalt wherein the aggregate and/or bitumen has been treated with an adsorbent under conditions to bind any contaminants in the aggregate and/or bitumen.

According to a third aspect, there is provided an asphalt mixture comprising aggregate and bitumen, wherein some or all of the aggregate and bitumen have been treated with an adsorbent under conditions to bind any contaminants in the aggregate and bitumen.

According to a fourth aspect, there is provided a method of neutralising and reconstructing a contaminated asphalt surface, the method comprising:
obtaining particles of asphalt raw material from the contaminated asphalt,
mixing the asphalt raw material with an adsorbent under conditions to bind contaminants in the asphalt raw material and stabilise the contaminants under asphalt mixing conditions,
mixing bitumen and, optionally, virgin aggregate and/or other additives with the adsorbent treated asphalt raw material to obtain an asphalt mix,
overlaying the obtained asphalt mix on the surface to obtain an asphalt surface.

In each of the first to fourth aspects, the contaminants that can be stabilised may be PFAS.

### DESCRIPTION OF EMBODIMENTS

The present disclosure is predicated on the inventors' surprising finding that the PFAS in PFAS contaminated asphalt can be stabilised to such an extent that the treated contaminated asphalt can be used as reclaimed asphalt (RAP) to make new asphalt surfaces. In other words, the PFAS in PFAS contaminated asphalt can be stabilised to such an extent that it does not substantially leach from the treated RAP and/or from new asphalt surfaces formed using the RAP. Furthermore, the PFAS in PFAS contaminated asphalt can be stabilised to such an extent that it is not substantially volatilized from the treated contaminated asphalt even at hot mix asphalt temperatures of up to about 190° C. When adsorbents have been previously added to another matrix such as soil, their thermal stability has not been tested at temperatures above about 55° C. These findings are surprising because the PFAS in PFAS contaminated asphalt could be bound in the bitumen or the aggregate components of the asphalt in which case it was not clear that the PFAS could be bound to another material to such an extent that it became stabilised in the asphalt. This finding is also surprising because asphalt is a complex chemical environment and, therefore, prior to the present inventors' work, it was not clear, whether adding an adsorbent to such a complex chemical environment would have any material effect on binding of PFAS.

The present disclosure also extends to other contaminants (i.e. other than PFAS) that may be present in asphalt. Some other inorganic contaminants that may be present in asphalt include heavy metals such as copper, zinc, cadmium and lead. Some other organic contaminants that may be present in asphalt include N-(1,3-dimethylbutyl)-N′-phenyl-p-phenylenediamine (6PPD) and 2-anilino-5-(4-methylpentan-2-ylamino)cyclohexa-2,5-diene-1,4-dione (6-PPD quinone or 6PPD-q). 6PPD is an organic chemical widely used as stabilising additive in tyres and 6PPD and 6PPD-q enter the environment through tyre wear. Both 6PPD and 6PPD-q present environmental concerns due to toxicity.

For ease of discussion, the stabilisation of PFAS contaminants will now be discussed. However, it will be appreciated that other contaminants can also be stabilised according to the present disclosure.

The term “stabilisation” and similar terms such as “stabilising” as used herein, refers to a process for the conversion of one or more contaminants to a less soluble, mobile and/or toxic form, thereby resulting in a reduction in the hazard potential of the material. The stabilisation process is also known in the art as “fixation”. The term “immobilisation” and similar terms such as “immobilising” as used herein, refers to a process of encapsulation of contaminants within a solid mass such as a monolithic solid of high structural integrity so as to reduce the leachability of contaminants, thereby resulting in a reduction in the hazard potential of the material.

Thus, provided herein is a method for the stabilisation of PFAS contaminants within an asphalt raw material. The method comprises mixing the asphalt raw material with an adsorbent under conditions to bind PFAS contaminants in the asphalt raw material and stabilise the PFAS contaminants under asphalt mixing conditions.

As discussed, many asphalt surfaces have become contaminated with PFAS as a result of firefighting or other industrial activities that have taken place on the asphalt. An example is asphalt surfaces at airports and airfields that have become contaminated with PFAS as a result of firefighting activities that have been carried out over the years. Replacement of these asphalt surfaces is difficult and expensive because the PFAS contaminated used asphalt material cannot be re-used or disposed of easily.

PFAS contaminants that may be stabilised in asphalt raw material using the methods described herein include sulphonate and carboxylate PFAS. The PFAS may be ionic, anionic or zwitterionic. Examples of PFAS contaminants that may be stabilised in asphalt raw material using the methods described herein include, but are not limited to, perfluoro-n-octanoic acid (PFOA), perfluorooctane sulfonate (PFOS), perfluoro-n-nonanoic acid (PFNA), sodium perfluoro-1-hexanesulfonate (PFHxS), perfluoro-n-hexanoic acid (PFHxA), potassium perfluoro-1-butanesulfonate (PFBS), perfluorobutanoic acid (PFBA), perfluoro-n-pentanoic acid (PFPeA), perfluoro-n-heptanoic acid (PFHpA), perfluoro-n-decanoic acid (PFDA), perfluoro-n-undecanoic acid (PFUnDA), perfluoro-n-dodecanoic acid (PFDoDA), perfluoro-n-tridecanoic acid (PFTrDA), perfluoro-n-tetradecanoic acid (PFTDA), perfluoro-n-hexadecanoic acid (PFHxDA), perfluoro-n-octadecanoic acid (PFODA), sodium perfluoro-1-pentanesulfonate (PFPeS), sodium perfluoro-1-heptanesulfonate (PFHpS), sodium perfluoro-1-nonanesulfonate (PFNS), sodium perfluoro-1-decanesulfonate (PFDS), sodium perfluoro-1-undecanesulfonate (PFUnDS), sodium perfluoro-1-dodecanesulfonate (PFDoDS), sodium perfluoro-1-tridecanesulfonate (PFTrDS), perfluoro-4-ethylcyclohexanesulfonate (PFECHS), 2,3,3,3-tetrafluoro-2-(1,1,2,2,3,3,3-heptafluoropropoxy) propanoic acid (Gen X) (HFPO-DA), perfluoro-2,5-dimethyl-3,6-dioxanonanoic acid (HFPO-TA), sodium dodecafluoro-3H-4,8-dioxanonanoate (DONA), perfluoro-4-oxapentanoic acid (PFMoPrA) (PFMPA), perfluoro-3,6-dioxaheptanoic acid (NFDHA), perfluoro-5-oxahexanoic acid (PFMOBA) (PFMBA), 3-perfluoropropyl propanoic acid (3:3) (3:3 FTCA), 3-perfluoropentyl propanoic acid (5:3) (5:3 FTCA), 3-perfluoroheptyl propanoic acid (7:3) (7:3 FTCA), perfluoro-(2-ethoxyethane)-sulfonic acid (PFEESA), potassium 9-chlorohexadecafluoro-3-oxanonane-1-sulfonate (F53B Major), potassium 11-chloroeicosafluoro-3-oxaundecane-1-sulfonate (F53B Minor), sodium 1H, 1H,2H,2H-perfluorohexane sulfonate (4:2) (4:2 FTSA), sodium 1H,1H,2H,2H-perfluorooctane sulfonate (6:2) (6:2 FTSA), sodium 1H,1H,2H,2H-perfluorodecane sulfonate (8:2) (8:2 FTSA), sodium 1H,1H,2H,2H-perfluorododecane sulfonate (10:2) (10:2 FTSA), perfluoro-1-butanesulfonamide (FBSA), perfluoro-1-hexanesulfonamide (FhxSA), perfluoro-1-octanesulfonamide (PFOSA), N-methylperfluoro-1-octanesulfonamidoacetic acid (N-MeFOSAA), N-ethylperfluoro-1-octanesulfonamidoacetic acid (N-EtFOSAA), N-methylperfluoro-1-octansulfonamide (N-MeFOSA), N-ethylperfluoro-1-octanesulfonamide (N-EtFOSA), 2-(N-methylperfluoro-1-octanesulfonamido)-ethanol (MeFOSE0, 2-(N-ethylperfluoro-1-octanesulfonamido)-ethanol (EtFOSE), carboxymethyldimethyl-3-[[(3,3,4,4,5,5,6,6,7,7,8,8,8-tridecafluorooctyl) sulfonyl]amino]propylammonium hydroxide (6:2 FTAB), sodium bis(1H,1H,2H,2H-[1,2-13C2]-perfluorooctyl)phosphate (6:2 diPaP), trifluoroacetic acid (TFA), hexafluoropropylene oxide dimer acid, etc.

The asphalt raw material can be any bitumen material, aggregate material, sand material, soil material or additive material that is suitable for use in new asphalt. Without limitation, the asphalt raw material will typically be used asphalt that is suitable for use as RAP.

As discussed, the PFAS present in used asphalt material that has been treated using the methods described herein has been found to be stabilised at asphalt mixing conditions including heating to temperatures up to about 190° C., such as about 140° C., 150° C., about 160° C., about 170° C., about 180° C. or about 190° C.

In the treatment step, the asphalt raw material is mixed with the adsorbent. Mixing can be carried out using any suitable method. For example, a measured amount of the adsorbent may be added to a known amount (by weight) of used asphalt material. The amount of adsorbent material added to the used asphalt will depend on factors including the specific adsorbent used, the concentration of PFAS in the used asphalt, etc. Typical amounts may be (by weight) from about 0.1% to about 10% or from about 0.1% to about 5%. Typical amounts may be (by weight) 0.1%, 0.25%, 0.5%, 1%, 2%, 3%, 4%, 5%, 6%, 7%, 8%, 9%, 10%, 11%, 12%, 13%, 14%, 15%, 16%, 17%, 18%, 19% or 20%.

In an alternative treatment step, the adsorbent may be added to the used asphalt material during the new asphalt mixing stage.

The added adsorbent may be mixed with the used asphalt material using any suitable mechanical mixing means.

The adsorbent that is used in the methods described herein may be a carbon-based adsorbent, mineral-based adsorbent, a clay-based adsorbent, a biopolymer-based adsorbent, an ion exchange resin or a combination of any two of the aforementioned.

As used herein the term “adsorbent” means any material that binds PFAS or other environmental contaminants by adsorption, electrostatic interaction, charge interaction, hydrophobic interaction, hydrophilic interaction, etc to reduce the mobility or solubility of the contaminant such that its leachability potential is reduced.

Suitable carbon-based adsorbents include, but are not limited to, activated carbon, carbon black, biochar, graphene, graphene oxide or derivatives, carbonaceous mixtures (e.g. high molecular weight organic compounds with carbon numbers greater than C25 and high carbon-to-hydrogen ratios), organic matter and carbon-based waste materials or by-products.

The mineral-based adsorbent may be any mineral material having a positive charge and may include double-layer hydroxide and metal organic framework (MOF). Examples of suitable mineral-based adsorbents include, but are not limited to, aluminium compounds and/or complexes and iron compounds and/or complexes. The aluminium compound and/or complex may comprise aluminium hydroxide, aluminium sulphate, alumina (aluminium oxide), activated alumina, or combinations thereof. For example, the aluminium compound and/or complex may comprise alum sludge. The iron compound and/or complex may be iron oxide.

Suitable clay-based adsorbents include, but are not limited to, zeolites, organoclays, clay minerals and surface modified clays (for example the commercially available Fluoro-sorb™ from CETCO). For example, the clay-based adsorbent may be kaolin or bentonite.

Suitable biopolymer-based adsorbents include, but are not limited to, cellulose-based adsorbents and protein-based adsorbents.

The ion exchange adsorbent may be an anionic or a non-anionic resin. For example, the commercially available ion exchange resin Purofine® PFA694E PFAS (available from Purolite).

In certain embodiments, the adsorbent comprises a combination of activated carbon and one or more clay and one or more aluminium compounds and/or complexes. A suitable product is available commercially under the trade name REMBIND™.

The treated PFAS contaminated used asphalt material can then be used as reclaimed asphalt (RAP). RAP may be used to form new asphalt surfaces by mixing with bitumen and, optionally, virgin aggregate. It is contemplated that 100% of the solids (i.e. aggregate, sand and other particulates) may be obtained from RAP. However, more commonly RAP is used in conjunction with virgin aggregate to form new asphalt mixtures after addition of bitumen. The amount of RAP used will depend on factors including the final structure or properties of the asphalt required. For example, a new asphalt mixture may be formed using from about (by weight) 10% RAP to about 50% RAP, such as about 10% RAP, about 20% RAP, about 30% RAP, about 40% RAP or about 50% RAP.

The treated PFAS contaminated used asphalt material RAP may be used as a component in hot mix asphalt, warm mixed asphalt, cold asphalt or foamed asphalt.

As required, other additives may be added to the new asphalt mixture. Other additives that may be used include, but are not limited to, common polymers such as EVA, SBS, SB, SBR, SBR latex, waxes, polychloroprene, isoprene, polybutadiene, acrylic and acrylic copolymers, carbon reinforced elastomers, glass derived sand, shredded plastics, ground tyre rubber and/or stabilisers. Advantageously, any PFAS contaminants present in any of the additives will also be treated with the adsorbent.

Also disclosed herein is aggregate and/or bitumen obtained from used asphalt wherein the aggregate and/or bitumen has been treated with an adsorbent under conditions to bind any PFAS contaminants in the aggregate and/or bitumen.

Also disclosed herein is an asphalt mixture comprising aggregate and bitumen, wherein some or all of the aggregate and bitumen have been treated with an adsorbent under conditions to bind any PFAS contaminants in the aggregate and bitumen.

Also disclosed herein is a method of neutralising and reconstructing a PFAS contaminated asphalt surface. The method comprises:
obtaining particles of asphalt raw material from the PFAS contaminated asphalt,
mixing the asphalt raw material with an adsorbent under conditions to bind PFAS contaminants in the asphalt raw material and stabilise the PFAS contaminants under asphalt mixing conditions,
mixing bitumen and, optionally, virgin aggregate with the adsorbent treated asphalt raw material to obtain an asphalt mix,
overlaying the obtained asphalt mix on the surface to obtain an asphalt surface.

### EXAMPLES

### Example 1—Evaluation of the Capacity of REMBIND™ Adsorbent to Stabilise PFAS in Asphalt Mixture and Sand

A trial was conducted to determine capacity of the commercially available REMBIND™ adsorbent to stabilise PFAS in an asphalt mixture and sands. The following samples were submitted for the trial:

### Airport Mix (Bitumen+PFAS Sand)

a. consisting of 7% PFAS contaminated sand (oven dried) without any REMBIND-200™ adsorbent and mixed into Airport AC14HD-C320 asphalt [Loose & Compacted blocks];
b. included to simulate actual leach performance of the material without the REMBIND™ adsorbent.

### Airport Mix+Rembind DRY

a. consisting of 7% PFAS Dry Contaminated sand (oven dried) blended with 5% of REMBIND-200™ adsorbent and mixed into Airport AC14HD-C320 asphalt [Loose & Compacted blocks]
b. included to simulate the leach performance of the material that is dried prior to mixing with the REMBIND™ adsorbent.
   Airport Mix+REMBIND™ adsorbent WET
a. consisting of 7% PFAS Wet Contaminated sand (as received) blended with 5% of Rembind-200 and mixed into Airport AC14HD-C320 asphalt [Loose & Compacted blocks]
b. included to simulate the performance of the material without drying prior to mixing with the Rembind.

### Methodology

Solid core samples were used for the initial leach trials.

The trial methodology adopted was Leaching Environmental Assessment Framework (LEAF) Method 1315-Mass Transfer Rates of Constituents in Monolithic or Compacted Granular Materials.

The 1315 method is a passive leaching methodology (no mechanical shaking as per standard leachate procedures). It is as a mass diffusion test, where material from the surface can diffuse/leach into the surrounding liquid in a manner similar to actual environmental conditions. There is sometimes entrainment of the elutriate (ultra-high purity (UHP) water) into the monolith surface that may release more material into the main body of liquid (e.g. contaminants) i.e. additional pathways & surface area for material to diffuse into the liquid. Generally, the method simulates repeated rainfall on the monolithic surface, which could represent a pavement.

To complete tests using the 1315 method:
the monolith (core) is sat or suspended in a UHP water elutriate
the volume (cm³) of elutriate was 9 (+1) times the surface area (cm²) of the core
   at least 10 mm of liquid in depth around the surface of the core was required (therefore matching the container to the core is required)
the elutriate was exchanged out and tested as per the schedule in Table 3-1. The elutriate exchange time/day is the point at which the core was removed from the liquid (3109 cm³)
   the elutriate was collected for analysis, then the core was placed in fresh UHP water elutriate for the subsequent time period (TOX).

Table 1 outlines the schedule for collecting and renewing the elutriate. This schedule was implemented for the three sample cores simultaneously.

TABLE 1
Schedule of Elutriate Renewals

| | Interval | | |
|---|---|---|---|
| Interval | Duration | Interval Duration | Cumulative Leaching |
| Label | (Hours) | (Days) | Time (Days) |
| T01 | 2 ± 0.25 | — | 0.08 |
| T02 | 23 ± 0.5 | — | 1 |
| T03 | 23 ± 0.5 | — | 2 |
| T04 | — | 5 ± 0.1 | 7 |
| T05 | — | 7 ± 0.1 | 14 |
| T06 | — | 14 ± 0.1 | 28 |
| T07 | — | 14 ± 0.1 | 42 |
| T08 | — | 7 ± 0.1 | 49 |
| T09 | — | 14 ± 0.1 | 63 |

### Results

The original PFAS contaminated sand used to create the trial mixtures had PFAS concentration of:
390 μg/kg Total Positive PFAS
380 μg/kg Total Positive PFOS & PFOA
390 μg/kg Total Positive PFHxS & PFOS

The leachate analysis results were consistent-low break-through of PFAS in the non REMBIND-200™ adsorbent core (max 0.003 μg/L Sum of PFHxS and PFOS, Total Positive PFOS & PFOA and Total PFAS) and very low break-through in the wet mix REMBIND-200™ adsorbent core (0.001 μg/L) but no detectable PFAS in the dry mix REMBIND-200™ adsorbent core.

All leachate concentrations were very low when compared to the initial sand concentrations, even when allowing for dilution in the mixture.

### Conclusion

The results of the trials suggest that the addition of REMBIND™ adsorbent to the asphalt mixture reduces leaching of PFAS over repeated exposures. Improved mixing of REMBIND™ adsorbent with the contaminated material (such as would be the case with a dry sand mix) improves performance but does not appear to be essential for good performance of the mixture in locking in PFAS contamination.

### Example 2—Resilient Modulus Testing

Resilient modulus testing according to AS/NZS 2891.13.1 was conducted on PFAS/adsorbent and control 10 mm 20% RAP asphalt laboratory-produced samples as described in Example 1. The samples contained REMBIND™ (REMRAP1), activated carbon (PACPS9), no adsorbent (Control) and a proprietary modified organoclay (Organoclay). The results are shown in Table 2.

TABLE 2
Results of resilient modulus tests

| | | Average Resilient Modulus |
|---|---|---|
| Test Report | Sample | (MPa) |
| RM_DNG24M- | REMRAP1 | 5000 |
| 00361 | | |
| RM_DNG24M- | PACPS900 | 4900 |
| 00360 | | |
| RM_DNG24M- | Control | 4600 |
| 00358 | | |
| RM_DNG24M- | Organoclay | 4200 |
| 00359 | | |

As can be seen from the results, there was no detrimental impact on modulus with the REMRAP1 sample which had an Average Resilient Modulus (MPa) of 5000. Similarly, there was no detrimental impact on modulus with the PACPS900 which had an Average Resilient Modulus (MPa) of 4900, so the inclusion of those two adsorbents improved the resilient modulus results. The organoclay produced a slightly lower Average Resilient Modulus (MPa) of 4200.

These results indicate that the inclusion of the adsorbents did not significantly change the resilient modulus. All the results were within the expected typical range for a 10 mm asphalt.

### Example 3—Assessment of Leachability of Adsorbent Treated PFAS Contaminated RAP

Australian Standard Leaching Procedure (ASLP) tests (Australian Standard AS4439) were carried out to determine the potential leaching hazards associated with adsorbent treated PFAS contaminated RAP samples.

PFAS/adsorbent and control 10 mm 20% RAP asphalt laboratory-produced samples were subjected to ASLP tests. The samples were:
RAP: Control 10 mm 20% RAP asphalt
RAP+Binder: 10 mm 20% RAP asphalt plus Bitumen Class 170 binder (320 w/0.3% evotherm)
RAP+Binder+RemRAP 1: 10 mm 20% RAP asphalt plus Bitumen Class 170 binder (320 w/0.3% evotherm) plus REMBIND™ adsorbent
RAP+Binder+PACPS900: 10 mm 20% RAP asphalt plus Bitumen Class 170 binder (320 w/0.3% evotherm) plus activated carbon (PACPS9) adsorbent
RAP+Binder+Organoclay: 10 mm 20% RAP asphalt plus Bitumen Class 170 binder (320 w/0.3% evotherm) plus proprietary modified organoclay.

Each sample was tested prior to heat treatment (‘Ambient Temperature’) and after heat treatment at 140° C. The leaching tests were conducted in duplicate. The results are shown in Table 3.

TABLE 3
ASLP leaching test results on heated and non-heated samples

| | | | | | | | | Sums | |
|---|---|---|---|---|---|---|---|---|---|
| | Perfluoroalkane | | | | Perfluoroalkane | | | Sum | Sum |
| | Sulfonic Acids | | | | Carboxylic Acids | | | (PFHxS + | of |
| | PFBS | PFHxS | PFHpS | PFOS | PFBA | PFHxA | PFOA | PFOS) | PFAS |
| | μg/L | μg/L | μg/L | μg/L | μg/L | μg/L | μg/L | μg/L | μg/L |
| RAP | 446.68 | 856.14 | 38.89 | 194.40 | 908.44 | 105.84 | 228.30 | 1050.54 | 2784.41 |
| Ambient | | | | | | | | | |
| Temperature | | | | | | | | | |
| (Average) | | | | | | | | | |
| RAP | 218.27 | 347.95 | 13.77 | 44.86 | 448.32 | 111.51 | 113.01 | 392.81 | 1300.43 |
| Heated to 140° C. | | | | | | | | | |
| (Average) | | | | | | | | | |
| RAP + Binder | 315.48 | 583.94 | 26.78 | 151.96 | 635.10 | 107.52 | 161.72 | 735.89 | 1986.34 |
| Ambient | | | | | | | | | |
| Temperature | | | | | | | | | |
| (Average) | | | | | | | | | |
| RAP + Binder | 219.28 | 351.90 | 15.94 | 58.54 | 408.11 | 101.03 | 113.78 | 410.44 | 1271.24 |
| Heated to 140° C. | | | | | | | | | |
| (Average) | | | | | | | | | |
| RAP + Binder + | 17.72 | 0.32 | 0.00 | 0.03 | 510.75 | 45.07 | 0.18 | 0.35 | 574.26 |
| RemRAP 1 | | | | | | | | | |
| Ambient | | | | | | | | | |
| temperature | | | | | | | | | |
| (Average) | | | | | | | | | |
| RAP + Binder + | 6.22 | 0.11 | 0.00 | 0.01 | 204.23 | 19.95 | 0.08 | 0.12 | 230.66 |
| RemRAP 1 | | | | | | | | | |
| Heated to 140° C. | | | | | | | | | |
| (Average) | | | | | | | | | |
| RAP + Binder + | 0.19 | 0.05 | 0.00 | 0.01 | 31.86 | 8.16 | 0.13 | 0.06 | 40.40 |
| PACPS900 | | | | | | | | | |
| Ambient | | | | | | | | | |
| Temperature | | | | | | | | | |
| (Average) | | | | | | | | | |
| RAP + Binder + | 4.21 | 2.07 | 0.03 | 0.92 | 171.80 | 51.66 | 3.09 | 2.99 | 233.87 |
| PACPS900 | | | | | | | | | |
| Heated to 140° C. | | | | | | | | | |
| (Average) | | | | | | | | | |
| RAP + Binder + | 2.34 | 0.06 | 0.00 | 0.01 | 313.73 | 10.64 | 0.04 | 0.07 | 326.81 |
| Organoclay | | | | | | | | | |
| Ambient | | | | | | | | | |
| temperature | | | | | | | | | |
| (Average) | | | | | | | | | |
| RAP + Binder + | 0.11 | 0.01 | 0.00 | 0.00 | 33.93 | 0.48 | 0.01 | 0.01 | 34.54 |
| Organoclay | | | | | | | | | |
| Heated to 140° C. | | | | | | | | | |
| (Average) | | | | | | | | | |

The data show that adsorbents provide long-term stability and vastly reduce PFAS leachability levels. The data also show that adsorbents are effective at binding PFAS even at elevated temperatures.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A method for the stabilisation of contaminants within an asphalt raw material, the method comprising mixing the asphalt raw material with an adsorbent under conditions to bind contaminants in the asphalt raw material and stabilise the contaminants under asphalt mixing conditions.

2. The method according to claim 1, wherein the contaminants are PFAS.

3. The method according to claim 1, wherein the contaminants are selected from the group consisting of N-(1,3-dimethylbutyl)-N′-phenyl-p-phenylenediamine (6PPD) and 2-anilino-5-(4-methylpentan-2-ylamino)cyclohexa-2,5-diene-1,4-dione (6-PPD quinone).

4. The method according to claim 1, wherein the asphalt mixing conditions include heating to temperatures from about 140° C.

5. The method according to claim 4, wherein the asphalt mixing conditions include heating to temperatures up to about 190° C.

6. The method according to claim 1, wherein the stabilisation of contaminants includes immobilisation of the contaminants.

7. The method according to claim 1, wherein the stabilisation of contaminants includes a reduction in volatilization of the contaminants.

8. The method according to claim 1, wherein the adsorbent is at least one of a carbon-based adsorbent, a mineral-based adsorbent, a clay-based adsorbent, a biopolymer-based adsorbent, an ion exchange resin, or a combination thereof.

9. The method according to claim 8, wherein the carbon-based adsorbent is selected from one or more of the group consisting of activated carbon, biochar, graphene, graphene oxide or derivatives, carbon black, carbonaceous mixture, organic matter and carbon-based waste materials or by-products.

10. The method according to claim 8, wherein the mineral-based adsorbent is selected from one or more of the group consisting of aluminium compounds and/or complexes and iron compounds and/or complexes.

11. The method according to claim 10, wherein the aluminium compound and/or complex comprises aluminium hydroxide, aluminium sulphate, alumina (aluminium oxide), activated alumina, or combinations thereof.

12. The method according to claim 10, wherein the iron compound and/or complex comprises iron oxide.

13. The method according to claim 8, wherein the clay-based adsorbent is selected from one or more of the group consisting of zeolites, organoclays, clay minerals and surface modified clays.

14. The method according to claim 13, wherein the clay-based adsorbent is kaolin.

15. The method according to claim 8, wherein the biopolymer-based adsorbent is selected from one or more of the group consisting of cellulose based adsorbents and protein-based adsorbents.

16. The method according to claim 8, wherein the ion exchange adsorbent is selected from one or more of the group consisting of anionic resins and non-anionic resins.

17. The method according to claim 1, wherein the asphalt raw material is selected from one or more of the group consisting of bitumen material, aggregate material, sand material, soil material, and additive material.

18. Aggregate and/or bitumen obtained from used asphalt wherein the aggregate and/or bitumen has been treated with an adsorbent under conditions to bind any contaminants in the aggregate and/or bitumen.

19. (canceled)

20. A method of neutralising and reconstructing a contaminated asphalt surface, the method comprising:
obtaining particles of asphalt raw material from the contaminated asphalt, mixing the asphalt raw material with an adsorbent under conditions to form an absorbent treated asphalt raw material that binds contaminants in the asphalt raw material and stabilises the contaminants under asphalt mixing conditions, mixing bitumen and, optionally, virgin aggregate with the adsorbent treated asphalt raw material to obtain an asphalt mix,
overlaying the asphalt mix on the surface to obtain an asphalt surface.

21. The method of claim 20, wherein the contaminants are PFAS.
